(19) United States
(12) Patent Application Publication
(10) Pub. No.: US 2006/0237570 A1
(43) Pub. Date: Oct. 26, 2006

(54) Seat belt retractor and seat belt device

(75) Inventors: Masato Takao, Tokyo (JP); Koji Tanaka, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/398,525

(22) Filed: Apr. 6, 2006

(30) Foreign Application Priority Data
Apr. 20, 2005 (JP) 2005-122259

(51) Int. Cl. B60R 22/46

(52) U.S. Cl. 242/374; 242/382

(57) ABSTRACT

The disclosed seat belt retractor may be useful in smoothly performing the storing operation of a seat belt in the seat belt retractor to be mounted on a vehicle in which the power transmission mechanism is switched from a connected state to a disconnected state by means of a rotational speed difference between the electric motor and the spool so as to release the connection between the electric motor and the spool. The seat belt retractor may comprise a spool for retracting and unwinding a seat belt, an electric motor, a power transmission mechanism, a control unit for controlling the electric motor and the power transmission mechanism, and a detecting unit for detecting whether the seat belt is held during the retraction of the seat belt.

### BACKGROUND

The present invention relates to a seat belt retractor mounted on a vehicle.

In the related art, a seat belt device for restraining a vehicle occupant is known to protect the vehicle occupant by use of a seat belt (also known as a “webbing”). For example, Japanese PCT Japanese Publication No. 2003-507252 (the “'252 publication”) discloses a structure for a seat belt retractor, which performs the retracting operation and the unwinding operation of the seat belt by controlling an electric motor to rotate a spool. The '252 publication discloses the structure of the seat belt retractor and provides a possibility in which the retracting operation and the unwinding operation using the spool are performed by the electric motor. In addition, in the seat belt retractor in which a spool is operated by the electric motor, a power transmission mechanism is interposed between the electric motor and the spool. The power transmission mechanism is switched from a connected state to a disconnected state by a rotational speed difference between the electric motor and the spool so that the connection between the electric motor and the spool is released.

In the structure in which the power transmission mechanism is interposed between the electric motor and the spool like the above-mentioned seat belt retractor, a tensile force is applied to the seat belt during a storing operation of the seat belt. Specifically, since the vehicle occupant withdraws the seat belt, the seat belt comes into contact with the shoulder, arms or the like of the vehicle occupant or the seat belt interferes with obstacles. As a result, the seat belt is held and a tensile force is applied to the seat belt. In a case in which the vehicle occupant withdraws the seat belt, the power transmission mechanism is switched to the disconnected state when the seat belt is held. Then, after a predetermined time, the power transmission mechanism is again switched to the connected state so that a control function for performing the storage operation of the seat belt can be performed. Thus, the vehicle occupant can withdraw the seat belt.

When the vehicle occupant withdraws the seat belt, the control function is effective. However, when the seat belt merely interferes with the vehicle occupant or obstacles, it takes a long time to completely store the seat belt. For this reason, there is a problem in that the vehicle occupant feels discomfort.

The present application has been made to solve the above-mentioned problem. It is an object of an embodiment of the present invention to provide a technology useful in smoothly performing the storing operation of the seat belt in the seat belt retractor, which is to be mounted on a vehicle, in which the power transmission mechanism is switched from a connected state to a disconnected state by a rotational speed difference between the electric motor and the spool so as to release the connection between the electric motor and the spool.

The invention can be configured to solve the above-mentioned problem. Although an embodiment of the present invention can be typically applied to a seat belt retractor mounted on a vehicle such as an automobile, other embodiments of the present invention can be applied to a vehicle other than the automobile, for example an airplane, a ship, an electric train, etc.

### SUMMARY

A first embodiment of the present can be a seat belt retractor that may include at least a spool, an electric motor, a power transmission mechanism, a control unit, a first detecting unit, and a second detecting unit.

The spool can include a member for retracting or unwinding the seat belt. The seat belt to be retracted or unwound by the spool is a long belt fastened around a vehicle occupant. Typically, since the seat belt is fastened around the vehicle occupant seated in a vehicle seat during the vehicle collision, the vehicle occupant can be protected.

The power transmission mechanism may include a mechanism that is interposed between the electric motor and the spool and may form a connected state in which the electric motor and the spool are connected to each other and a disconnected state in which the connected state is released. The power transmission mechanism can be called a “clutch” in which gear members or the like are combined.

The connected state of the power transmission mechanism can be a state in which the spool is mechanically connected to the power transmission mechanism so that the power of the electric motor can be transmitted to the spool through the power transmission mechanism. Accordingly, when the electric motor is driven in the connected state, the power of the electric motor is transmitted to the spool through the power transmission mechanism. In addition, when the electric motor is stopped in the connected state, the power of the electric motor is not transmitted to the spool. However, since a high unwinding resistance is applied to the spool due to the power transmission mechanism mechanically connected to the spool, a state is formed in which the unwinding (or withdrawal) of the seat belt from the spool is regulated. Specifically, it is difficult to, if not impossible, to unwind (or withdraw) the seat belt.

Correspondingly, in the disconnected state of the power transmission mechanism, since an unwinding resistance from the power transmission mechanism mechanically disconnected to the spool is lowered regardless of the driving or stopping of the electric motor, it is possible to easily unwind (or withdraw) the seat belt from the spool.

The control unit can include a unit that controls the electric motor and the power transmission mechanism. The control unit may control the electric motor so that the electric motor is switched between the driving and the stopping. Furthermore, the control unit may control the power transmission mechanism so that the power transmission mechanism is switched between the connected state and the disconnected state or the like. The control unit can typically have a central processing unit (or CPU), input and output units, a memory unit, peripheral units, etc. The control unit may be provided solely for the seat belt retractor or it may be also be used as a control unit for controlling another system, such as a driving system or an electrical system of a vehicle.

When the electric motor is controlled so as to be rotated in a first direction in the connected state of the power transmission mechanism, the spool is controlled so as to be rotated in the belt retracting direction, and thus the seat belt is retracted. When the electric motor is controlled so as to be rotated in a second direction opposite to the first direction so as to switch the power transmission mechanism from the connected state to the disconnected state, the power transmission mechanism is switched from the connected state to the disconnected state by a rotational speed difference between the electric motor and the spool.

The first detecting unit can have a unit capable of detecting the occurrence of a holding of the seat belt during the retraction of the seat belt. In addition, the second detecting unit can have a unit capable of detecting whether the power transmission mechanism is in the connected state or the disconnected state. The first detecting unit and the second detecting unit may have detecting units separate from each other or may be used as a single unit. A structure, which uses a sensor for detecting the current of the motor to detect the occurrence of the holding of the seat belt or for detecting the state of the power transmission mechanism by means of the motor load corresponding to the detected current, or a structure that uses a hall IC sensor can be properly employed as the first detecting unit and the second detecting unit.

In particular, when the occurrence of the holding of the seat belt is detected on the basis of the detection result detected by the first detecting unit during the retraction of the seat belt, the control unit can control the electric motor so that the electric motor is rotated in the second direction at a holding state discrimination speed. The holding state discrimination speed is defined as a speed useful in detecting the holding state of the seat belt. Accordingly, only when the holding of the seat belt occurs due to the fact that the seat belt merely comes in contact with the shoulder, arms or the like of the vehicle occupant or the seat belt interferes with obstacles, the holding state discrimination speed can be properly set as a speed at which the rotational speed difference between the electric motor and the spool occurs. The holding state discrimination speed may have a specific speed value or may have any speed value within a predetermined speed range.

Furthermore, when the power transmission mechanism is in the connected state, the control unit can determine that the holding of the seat belt occurs due to the fact that the vehicle occupant withdraws the seat belt on the basis of the detection result detected by the second detecting unit during the control of the electric motor. When the power transmission mechanism is in the disconnected state, the control unit determines that the holding of the seat belt occurs due to the fact that the seat belt interferes with the vehicle occupant or obstacles.

According to the structure of the seat belt retractor according to the first embodiment, when the holding of the seat belt occurs during the retraction of the seat belt, it is possible to smoothly perform the storing operation of the seat by performing a control suitable for the factors causing the holding of the seat belt.

A second embodiment of the present invention can be a seat belt retractor in which the control unit controls the electric motor so that the electric motor is rotated in the second direction at a higher speed than the holding state discrimination speed when it is determined that the holding of the seat belt occurs due to the fact that the vehicle occupant withdraws the seat belt on the basis of the detection result detected by the second detecting unit.

According to the structure of the seat belt retractor according to this embodiment, when it is determined that the holding of the seat belt occurs due to the fact that the vehicle occupant withdraws the seat belt on the basis of the detection result detected by the second detecting unit, it is possible to control the electric motor so that the withdrawing operation of the seat belt is smoothly performed.

A third embodiment of the present invention can be a seat belt retractor in which each of the first and the second detecting units may include a motor current detector for detecting a current of the electric motor.

Moreover, in a case in which the occurrence of the holding of the seat belt is detected, when a current detected by the motor current detector is larger than a first reference current, the control unit determines that a holding of the seat belt has occurred. The first reference current is properly set on the basis of the motor current when the holding of the seat belt occurs or on the basis of the motor current when the holding of the seat belt does not occur.

In addition, in the case in which the occurrence of the holding of the seat belt is detected, when the current detected by the motor current detector is larger than a second reference current, the control unit determines that the power transmission mechanism is in the connected state. The second reference current is properly set on the basis of the motor current when the power transmission mechanism is in the connected state or on the basis of the motor current when the power transmission mechanism is in the disconnected state.

According to the structure of the seat belt retractor in this embodiment, the motor current detector for detecting the current of the motor can be used as a unit for detecting whether the holding of the seat belt occurs or not during the retraction of the seat belt and as a unit for detecting whether the power transmission mechanism is in the connected state or the disconnected state.

A fourth embodiment of the present invention can be a seat belt device, which includes at least a seat belt, a spool, an electric motor, a power transmission mechanism, a control unit, a first detecting unit, and a second detecting unit.

The seat belt is a long belt (or webbing) fastened around a vehicle occupant. Typically, since the seat belt is fastened around the vehicle occupant seated in a vehicle seat during the vehicle collision, the vehicle occupant can be protected. The spool, the electric motor, the power transmission mechanism, the control unit, the first detecting unit, and the second detecting unit can be substantially the same as those of the seat belt retractor described in any embodiments of the present application.

Therefore, according to the fourth embodiment, when the holding of the seat belt occurs during the retraction of the seat belt, it is possible to smoothly perform the storing operation of the seat by performing a control suitable for the factors causing the holding of the seat belt.

A fifth embodiment of the present invention can be a seat belt device in which, when it is determined that the holding of the seat belt occurs due to the fact that the vehicle occupant withdraws the seat belt on the basis of the detection result detected by the second detecting unit, the control unit can control the electric motor so that the electric motor is rotated in the second direction at a higher speed than the holding state discrimination speed.

According to the structure of the fifth embodiment, when it is determined that the holding of the seat belt occurs due to the fact that the vehicle occupant withdraws the seat belt on the basis of the detection result detected by the second detecting unit, it is possible to control the electric motor so that the withdrawing operation of the seat belt is smoothly performed.

A sixth embodiment the present invention can be a seat belt device in which each of the first and the second detecting units includes a motor current detector for detecting a current of the electric motor.

Moreover, in a case in which the occurrence of the holding of the seat belt is detected, the control unit determines that the holding of the seat belt occurs when a current detected by the motor current detector is larger than a first reference current. The first reference current can be properly set on the basis of the motor current when the holding of the seat belt has occurred or on the basis of the motor current when the holding of the seat belt has not occurred.

In addition, in the case in which the occurrence of the holding of the seat belt is detected, the control unit determines that the power transmission mechanism is in the connected state when the current detected by the motor current detector is larger than a second reference current. The second reference current can be properly set on the basis of the motor current when the power transmission mechanism is in the connected state or on the basis of the motor current when the power transmission mechanism is in the disconnected state.

According to the structure of this embodiment of the present invention, the motor current detector for detecting the current of the motor can be used as a unit for detecting whether the holding of the seat belt occurs or not during the retraction of the seat belt and as a unit for detecting whether the power transmission mechanism is in the connected state or the disconnected state.

A seventh embodiment of the present invention can be a vehicle with a seat belt device in which the seat belt device may include at least the seat belt device disclosed in any of the embodiments of the present invention. The vehicle of the seventh embodiment may have a seat belt device received in a receiving space of the vehicle, for example, the receiving space within a pillar, the receiving space within a seat, or the receiving space of other portions of the vehicle.

According to the structure of the vehicle with the seat belt device, it is possible to provide a vehicle with a seat belt device, which can smoothly perform the storing operation of the seat belt.

As described above, according to various embodiments of the present invention, in the structure of the seat belt retractor in which the power transmission mechanism is switched from the connected state to the disconnected state by means of a rotational speed difference between the electric motor and the spool, in particular, when the occurrence of the holding of the seat belt is detected during the retraction of the seat belt, it may be possible to smoothly perform the storing operation of the seat belt by a structure for performing a control suitable for the factors causing the holding of the seat belt.

It is to be understood that both the foregoing general description and the following detailed descriptions are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 shows a schematic structure of a seat belt device according to an embodiment of the invention.

FIG. 2 shows a schematic structure of the surrounding structure of the seat belt retractor according to an embodiment of the present invention.

FIG. 3 shows an exploded perspective view of the seat belt retractor according to an embodiment of the present invention.

FIG. 4(a) shows a perspective view of the seat belt retractor in which a retainer cover is removed and FIG. 4(b) shows a left side view of FIG. 4(a).

FIG. 5(a) shows a perspective view showing a sun gear member used in the seat belt retractor and FIG. 5(b) shows a perspective view of the sun gear member as seen from the IIIB side of FIG. 5(a).

FIG. 6 shows a left side view of a seat belt retractor in a power transmission interruption mode.

FIG. 7 shows a left side view of the seat belt retractor in a low speed reduction ratio power transmission mode.

FIG. 8 shows a left side view of the seat belt retractor in a high speed reduction ratio power transmission mode.

FIG. 9 shows a flow chart showing the retractor control process of the seat belt retractor according to an embodiment of the present invention.

### DETAILED DESCRIPTION

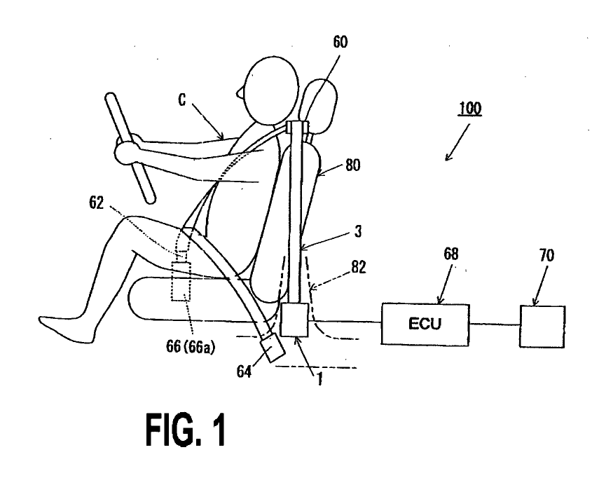

Hereinafter, various embodiments of the invention will be described in detail by referring to the accompanying drawings. First, embodiments of the present invention will be described with reference to FIGS. 1 to 4.

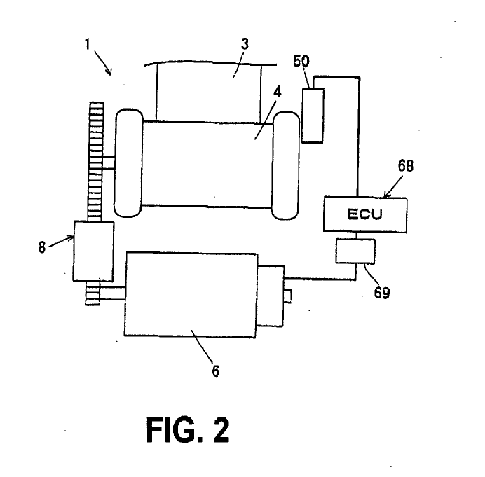

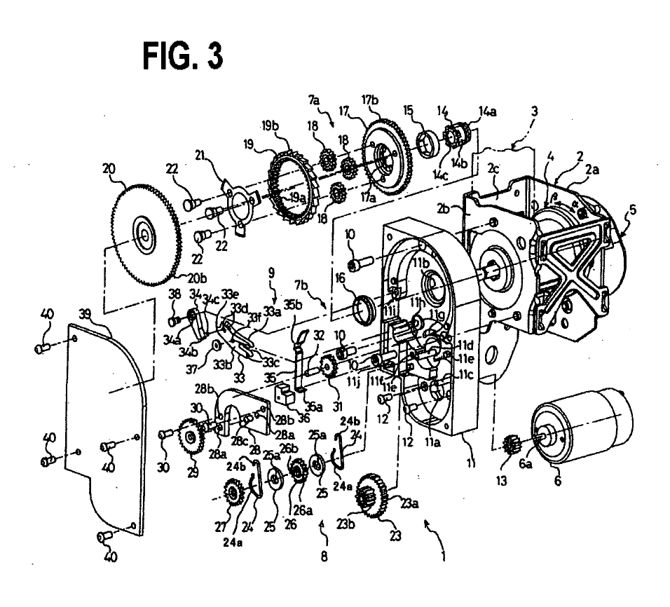

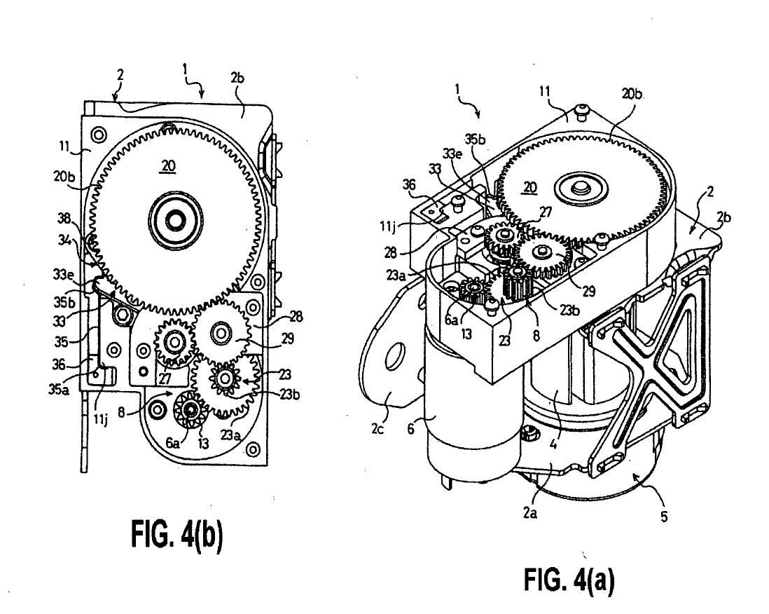

FIG. 1 shows a view of a structure of a seat belt device 100 according to an embodiment of the present invention; FIG. 2 shows a view of the surrounding structure of a seat belt retractor 1 shown in FIG. 1; and FIG. 3 shows an exploded perspective view of the seat belt retractor 1 according to an embodiment of the present invention. In addition, FIG. 4(a) shows a perspective view of a state in which a retainer cover is removed from the seat belt retractor 1 shown in FIG. 3 while FIG. 4(b) shows a left side view of FIG. 4(a). In the following description, as long as it is particularly not limiting, the directions “left” and “right” indicate the “left” and “right” directions in the drawings used for the description. Furthermore, the “clockwise direction” and the “counter-clockwise direction” indicate the “clockwise direction” and the “counter-clockwise direction” in the drawings used for the description.

As shown in FIG. 1, the seat belt device 100 of this embodiment is a seat belt device for a vehicle, which is mounted on a vehicle, i.e., a “vehicle with a seat belt device.” The seat belt device 100 can mainly have a seat belt retractor 1, a seat belt 3, and an ECU 68 or the like. In addition, a vehicle can be provided with an input element 70. The input element 70 may detect various information, such as information about a collision prediction or occurrence of a collision of the vehicle, the driving state of the vehicle, the seating position or the physique of a vehicle occupant seated on the seat, the surrounding traffic conditions, and the weather or the time zones. Then, the input element 70 inputs the detected information into the ECU 68. The detected information of the input element 70 is transmitted to the ECU 68 continuously or at predetermined times so that the detected information of the input element 70 can be used for controlling the operation of the seat belt device 100 or the like.

A seat belt 3 is a long belt (or webbing), which is used for restraining or releasing the vehicle occupant C seated on the vehicle seat, such as a driver's seat 80. The seat belt 3 can correspond to a “seat belt” of the present disclosure. The seat belt 3 is extracted from a seat belt retractor 1 fixed to the vehicle and is connected to an out anchor 64 by a tongue 62 via a shoulder guide anchor 60 provided in the portion of the safety device corresponding to the shoulder of the vehicle occupant C. The shoulder guide anchor 60 functions to lock and guide the seat belt 3 in the portion of the safety device corresponding to the shoulder of the vehicle occupant C. The seat belt 3 is fastened around the vehicle occupant C by inserting the tongue 62 into a buckle 66 fixed to the vehicle body. Furthermore, the buckle 66 is provided with a buckle switch 66a in which the buckle switch 66a detects the operation of the seat belt buckle (substantially the mounted state of the seat belt) by detecting the insertion of the tongue 62 into the buckle 66.

The seat belt retractor 1 is a unit capable of retracting and unwinding the seat belt 3 by means of a spool 4 to be described below and can correspond to a “seat belt retractor” of the present disclosure. As shown in FIG. 1, the seat belt retractor 1 can be mounted in the receiving space, which can be formed in a B pillar 82 of the vehicle.

The ECU 68 has a function that causes the seat belt retractor 1 to start on the basis of the signals from the input element 70 and various operating mechanisms to be controlled. The ECU 68 can have a CPU, input and output units, a memory unit, peripheral units, etc. In particular, the ECU 68 can control a motor 6, to be described below, of the seat belt retractor 1. Specifically, since the ECU 68 can control a supply amount or a supply direction of the current supplied to an electromagnetic coil of the motor 6, the rotational speed and the rotational direction of the motor shaft are varied. As described in detail below, the ECU 68 can control the driving of the motor 6 and can have units for switching a state in which a driving force of the motor 6 is transmitted to the spool 4 by controlling a power transmission mechanism 8 and a power transmission mode switching mechanism 9. The ECU 68 may correspond to a “control unit.” The seat belt retractor 1 can be controlled so as to be switched to a power transmission interruption mode, a low speed reduction ratio power transmission mode, or a high speed reduction ratio power transmission mode by the ECU 68. In addition, the ECU 68 may be provided solely to the seat belt retractor 1 or it may be also used as a control unit for controlling another system, such as a driving system or an electrical system of the vehicle.

As shown in FIG. 2, the seat belt retractor 1 is provided with a detecting sensor 50 for directly detecting information on the rotation of the spool 4. The detecting sensor 50 can be a sensor for detecting the operational information of the rotation of the spool 4. The motor 6 can be controlled by the ECU 68 on the basis of the detected information detected by the detecting sensor 50. The presence or absence of the rotation, the rotational angle, the rotational direction, the rotational speed, the amount of the rotation or the like of the spool 4 can be appropriately used as the detected information detected by the detecting sensor 50.

Hereinafter, the seat belt retractor 1 according to one embodiment will be described in detail.

As shown in FIG. 3, the seat belt retractor 1 can mainly include a frame 2, a seat belt 3 for restraining the vehicle occupant as needed, a spool 4 for retracting the seat belt 3, a lock unit 5 that is provided on one side of the frame 2, a motor 6 for generating the rotational torque to be applied to the spool 4, a power transmission mechanism 8, and a power transmission mode switching mechanism 9. The lock unit 5 can be operated to prevent the spool 4 from being rotated in the belt withdrawing direction α at the time when a deceleration larger than a predetermined deceleration, such as a collision or the like, occurs. The power transmission mechanism 8 can have a high speed reduction ratio mechanism 7a, which reduces the rotational speed of the motor 6 at a relatively high speed reduction ratio and then transmits the rotational speed to the spool 4, and a low speed reduction ratio mechanism 7b, which reduces the rotational speed of the motor 6 at a relatively low speed reduction ratio and then transmits the rotational speed to the spool 4. The power transmission mechanism 8 can have a first power transmission path and a second power transmission path set therein so as to selectively transmit the rotational torque of the motor 6 to the spool 4 through any one of the first power transmission path and the second power transmission path. The power transmission mode switching mechanism 9 selectively switches the power transmission mechanism 8 to any one of the first power transmission path and the second power transmission path.

The power transmission mechanism 8 and the power transmission mode switching mechanism 9 are provided between the motor 6 and the spool 4 to construct a unit (so-called “clutch”) for forming a connected state or a disconnected state between the motor 6 and the spool 4 and can correspond to a “power transmission mechanism” of the present disclosure. In the connected state, the power of the motor 6 is transmitted to the spool 4. Furthermore, in the connected state, a high unwinding resistance is applied to the spool 4 when the motor 6 is stopped. Therefore, the seat belt enters into a state in which an unwinding (or withdrawal) of the seat belt from the spool is regulated. Correspondingly, in the disconnected state, the seat belt 3 can be easily unwound (or withdrawn) from the spool 4 due to the unwinding resistance being lowered.

The frame 2 can have a pair of sidewalls 2a and 2b that are disposed parallel to each other and a backboard for connecting the sidewalls 2a and 2b to each other. The spool 4 for retracting the seat belt 3 is rotatably provided between the sidewalls 2a and 2b in the frame 2. A spool of the seat belt retractor 1, which is known in the related art, can be used as the spool 4. The spool 4 includes a member for retracting and unwinding the seat belt and can correspond to a “spool” of the present disclosure.

A lock unit 5 is mounted on one sidewall 2a. A lock unit of a seat belt retractor, which is known in the related art, can be used as the lock unit 5. That is, for example, when a vehicle sensor detects that the deceleration applied to the vehicle is larger than a predetermined deceleration (a deceleration detecting sensor) or when a webbing sensor detects that a speed of withdrawing the seat belt 3 is higher than a predetermined speed (a belt withdrawal speed detecting sensor), the lock unit 5 can be operated to prevent the spool 4 from rotating in the belt withdrawing direction α.

Furthermore, although not shown, a force limiter mechanism, such as an energy absorbing mechanism (hereinafter referred to as a “EA mechanism”), which is known in the related art, can be provided between the spool 4 and the lock unit 5. When the seat belt 3 is prevented from withdrawing by the lock unit 5, the force limiter mechanism limits the load of the seat belt 3. For example, a torsion bar, which is known in the related art, can be used as the EA mechanism. When the seat belt 3 is prevented from withdrawing by the operation of the lock unit 5, the torsion bar is twisted and deformed so that the load of the seat belt 3 is limited and the impact energy is absorbed.

As shown in FIGS. 3 and 4(a), the motor 6 is mounted on the surface of the retainer 11 facing the frame 2 by means of a pair of screws 12. The retainer 11 is mounted on the other sidewall 2b of the frame 2 by means of three screws 10. A motor rotary shaft 6a of the motor 6 passes through a through-hole 11a of the retainer 11. A motor gear 13 having external teeth is mounted on the motor rotary shaft 6a, which protrudes toward the opposite side to the surface of the retainer 11 facing the frame 2. The motor gear 13 is rotated with the motor rotary shaft 6a as one unit. The motor 6 can be an electric motor and can corresponds to an “electric motor.”

As shown in FIG. 3, a connector 14 may be provided in the rotational direction thereof between both the spool 4 and the above-mentioned EA mechanism (for example, a torsion bar) and the speed reduction ratio mechanisms 7a and 7b. The connector 14 can include a first rotatable connecting part 14a that is connected to both the spool 4 and the EA mechanism in the rotational direction thereof; a second rotatable connecting part 14b that is connected to a connector bearing 15 in the rotational direction thereof; and a third rotatable connecting part 14c that is formed in a spline-shape and is connected to the speed reduction ratio mechanisms 7a and 7b in the rotational direction thereof.

Although not clearly shown in FIG. 3, the first rotatable connecting part 14a can be formed in a polygonal tube shape. An outer surface of the first rotatable connecting part 14a is connected to the spool 4 so as to be rotated with the spool 4 as one unit. An inner surface of the first rotatable connecting part 14a is connected to the EA mechanism (for example, a torsion bar) so as to be rotated with the EA mechanism as one unit. Since the rotatable connection structure between the first rotatable connecting part 14a, the connector 14, the spool 4, and the EA mechanism are known in the related art, the detailed description thereof is omitted here.

The outer surface of the second rotatable connecting part 14b is formed in a polygonal shape while the inner surface of the connector bearing 15 is formed in the same polygonal shape as the outer surface of the connecting part 14b. The connector bearing 15 is fitted to the second rotatable connecting part 14b so as to be mounted on the connector 14 so that the connector bearing 15 cannot be rotated relative to the connector 14. Since the connector bearing 15 is rotatably supported relative to a retainer bearing 16, the connector 14 is rotatably supported in the retainer bearing 16.

The third rotatable connecting part 14c can have a predetermined number of engaging grooves, such as spline grooves, which extend in the axial direction, at regular intervals in the circumferential direction.

The high speed reduction ratio mechanism 7a may include an annular carrier gear 17, a predetermined number (for example, three are shown in FIG. 3) of planet gears 18 rotatably mounted on the carrier gear 17, an annular ring member 19, and a sun gear member 20.

A predetermined number of engaging grooves, such as spline grooves, which extend in the axial direction, are formed on the inner circumferential surface 17a of the carrier gear 17 facing the connector 14 in the circumferential direction thereof at regular intervals. The engaging grooves formed on the inner circumferential surface 17a are engaged with the protrusions formed between the engaging grooves of the third rotatable connecting part 14c. The protrusions formed between the engaging grooves of the inner circumferential surface 17a are engaged with the engaging grooves of the third rotatable connecting part 14c. Accordingly, the carrier gear 17 is connected to the connector 14 so as not to be rotated relative to the connector 14. That is, the carrier gear 17 rotates with the connector 14 as one unit. In addition, external teeth 17b are formed on the outer circumferential surface of the carrier gear 17.

The planet gears 18 can be rotatably mounted on the carrier gear 17 by means of the speed reduction pins 22 with a speed reduction plate 21 interposed therebetween.

The ring member 19 has an internal gear 19a and ratchet teeth 19b formed on the outer circumferential surface thereof. The internal gear 19a and the ratchet teeth 19b are rotated as one unit.

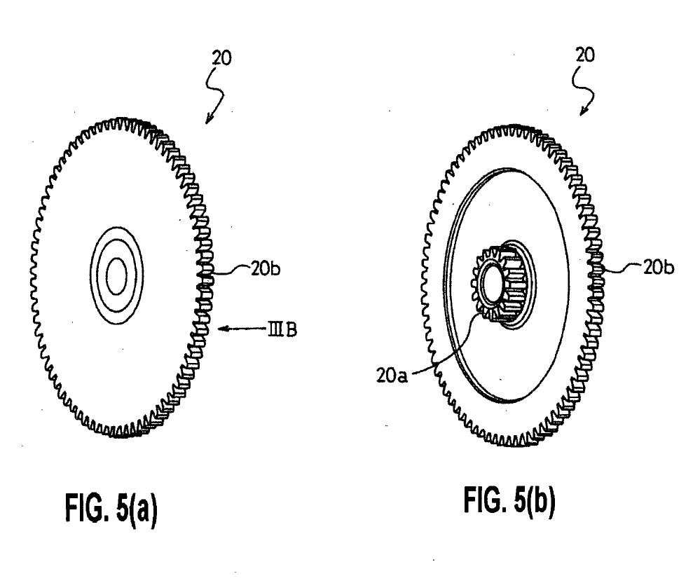

As shown in FIGS. 5(a) and 5(b), the sun gear member 20 is provided with large diametric external teeth 20b and a sun gear 20a that has small diametric external teeth. The sun gear 20a and the external teeth 20b are rotated as one unit.

When each of the planet gears 18 supported on the carrier gear 17 are engaged with the sun gear 20a and the internal gear 19a, the planetary mechanism is constructed. Accordingly, the high speed reduction ratio mechanism 7a has a planetary gear speed reduction mechanism in which an output of the carrier gear 17 is obtained by an input of the sun gear 20a.

In addition, as shown in FIG. 3, the power transmission mechanism 8 can include a connector gear 23, a pair of clutch springs 24, a pair of pulleys 25, a lower connector gear 26 having external teeth, an upper connector gear 27 having external teeth, a guide plate 28, and an idle gear 29 having external teeth.

The connector gear 23 can be rotatably supported by a rotary shaft 11c that stands on the retainer 11. The connector gear 23 can include a first connector gear 23a that has large diameter external teeth and a small diametric second connecter gear 23b. The first and second connecter gears 23a and 23b are rotated with each other as one unit. In this case, as shown in FIGS. 4(a) and 4(b), the large diametric first connector gear 23a is always engaged with the motor gear 13.

As shown in FIG. 3, rotary shafts 26a (only one rotary shaft 26a is shown in FIG. 3) protrude on both surfaces of the lower connector gear 26 while a through-hole 26b is formed to pass through the rotary shafts 26a in the axial direction thereof. Each of the rotary shafts 26a is formed with flat portions and is inserted into the slot 25a of the corresponding pulley 25 so that the flat planes of the flat portions are fitted in the slot. For this reason, each of the pulleys 25 is supported on one of the surfaces of the lower connector gear 26 and is to be rotated with the lower connector gear 26 as one unit. The first curved locking portions 24a of the clutch springs 24 are locked onto the pulleys 25. Also, the upper connector gear 27 is supported on one rotary shaft 26a of the lower connector gear 26 and is to be rotated with the lower connector gear 26 as one unit. The pulleys 25, the lower connector gear 26, and the upper connector gear 27 are rotatably supported by a rotary shaft 11d that stands on the retainer 11.

A pair of supporting shafts 11e, which stands on the retainer 11, are correspondingly inserted into a pair of holes 28a formed on the guide plate 28 so that the guide plate 28 is supported by the supporting shafts 11e. Then, a pair of screws 30 are fastened into a pair of screw holes 11f, which are formed on the retainer 11 while passing through corresponding screw holes on the guide plate 28 so as to mount the guide plate 28 on the retainer 11. The idle gear 29 is rotatably supported on a rotary shaft 28c that stands on the guide plate 28.

As shown in FIGS. 4(a) and 4(b), the idle gear 29 is always engaged with the external teeth 20b of the sun gear member 20, the small diametric second connecter gear 23b of the connector gear 23, and the upper connector gear 27.

Furthermore, the low speed reduction ratio mechanism 7b can include the upper connecter gear 27, the lower connector gear 26, a clutch gear 31, and the carrier gear 17.

Accordingly, the rotational torque of the motor 6 transmitted to the idle gear 29 is transmitted to the spool 4 from the idle gear 29 through the low speed reduction ratio mechanism 7b or is transmitted to the spool 4 from the idle gear 29 through the high speed reduction ratio mechanism 7a.

As shown in FIG. 3, the power transmission mode switching mechanism 9 includes a clutch gear 31 having external teeth, a rotary shaft 32, a clutch arm 33, a clutch pawl 34, a resistance spring 35, and a spring stopper 36.

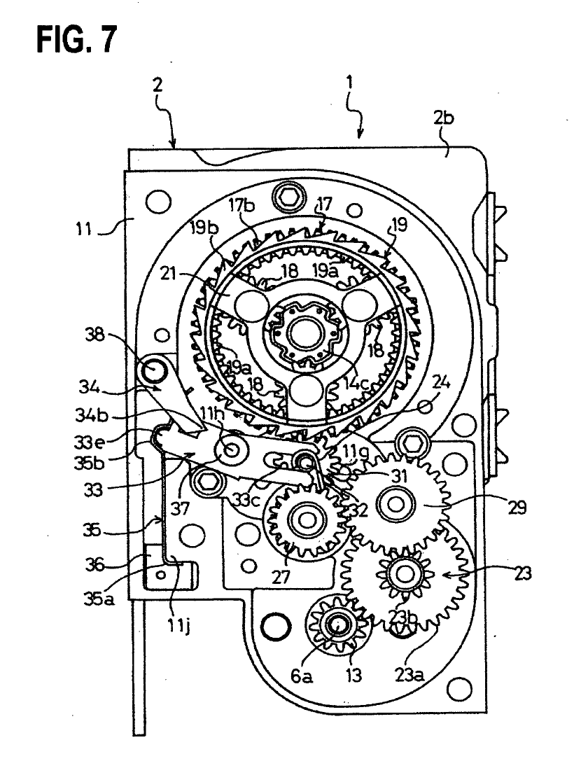

As shown in FIG. 7, the clutch gear 31 can be engaged with the external teeth 17b of the carrier gear 17, which has a diameter larger than that of the clutch gear 31. Furthermore, although not shown, the clutch gear 31 is always engaged with the lower connector gear 26. The clutch gear 31 is rotatably supported by the rotary shaft 32, which passes through a central hole 31a of the clutch gear 31.

The clutch arm 33 can include both sidewalls 33a and 33b and a bottom portion (not shown) so as to have a U-shaped cross-section. One end of both the sidewalls 33a and 33b protrudes from the bottom portions thereof and the protruding portions have corresponding supporting grooves 33c. The clutch gear 31 is disposed between the protrusions of the sidewalls 33a and 33b. Both ends of the rotary shaft 32, which protrude from both surfaces of the clutch gear 31, are supported by the corresponding supporting grooves 33c so as to be moved along the supporting grooves 33c. Furthermore, second curved locking portions 24b of the clutch springs 24 are locked on protruding portions of the rotary shaft 32, which protrude from the sidewalls 33a and 33b. One end of the rotary shaft 32 is inserted into a guide hole 11g, which is formed through the retainer 11, so as to be supported by the guide hole. The guide hole 11g has a shape of an arc of a circle whose center is on the axis of the rotary shaft 11d. Accordingly, the rotary shaft 32 is guided by the guide hole 11g so as to be movable along the circumference of the circle whose center is on the axis of the rotary shaft 11d.

Moreover, the other ends of the sidewalls 33a and 33b are provided with slots 33d and a substantially circular arc-shaped engaging portion 33e. Supporting holes 33f are formed through the sidewalls 33a and 33b in the middle thereof in the longitudinal direction. A supporting shaft 11h standing on the retainer 11 is inserted into the supporting holes 33f so that the clutch arm 33 is rotatably supported. The supporting shaft 11h is provided with an E-ring 37 mounted thereon so as not to be separated from the supporting holes 33f.

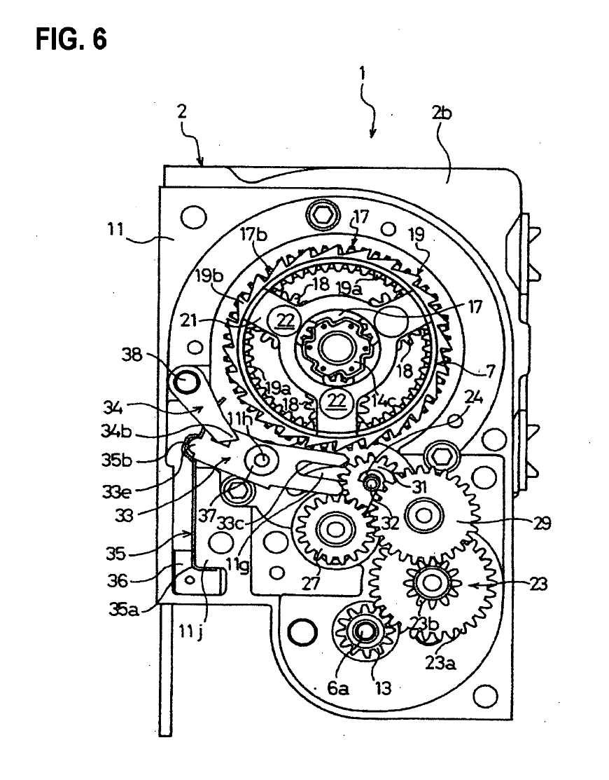

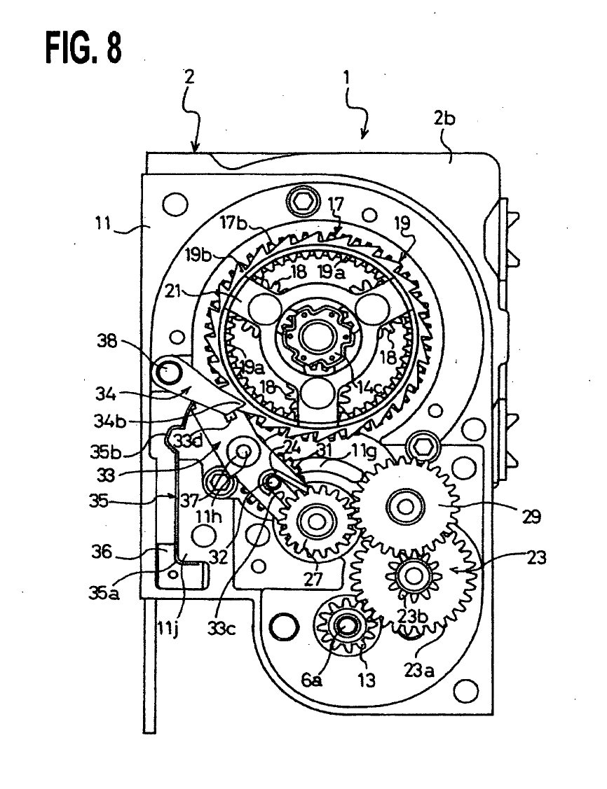

A supporting hole 34a is formed at one end of the clutch pawl 34 while an engaging hook 34b is formed at the other end. In addition, an engaging pin 34c is provided to stand at the other end of the clutch pawl 34, that is, on the side of the engaging hook 34b. The engaging pin 34c is inserted into the slot 33d of the clutch arm 33, can be rotated relative to the clutch arm 33, and can be relatively moved along the slot 33d. As shown in FIG. 6, the clutch pawl 34 is rotatably mounted on the retainer 11 by inserting a pawl pin 38 into a pin hole 11i f the retainer 11 through the supporting hole 34a. Then, as shown in FIG. 8, the engaging hook 34b can be engaged with the ratchet teeth 19b against the clockwise rotation of the ring member 19, which correspond to the belt withdrawing direction α. For this reason, when the engaging hook 34b is engaged with the ratchet teeth 19b, the ring member 19 is not rotated in the clockwise direction.

The resistance spring 35 can have a strip-shaped leaf spring. The resistance spring 35 has an L-shaped supporting portion 35a at the lower end and a U-shaped recess 35b on the upper portion above the center of the longitudinal axis. A portion of the resistance spring 35 between the recess 35b and the supporting portion 35a is formed in a planar shape while a portion between the recess 35b and the upper end is formed in a curved shape.

The engaging portion 33e of the clutch arm 33 is engaged with the recess 35b and can be disengaged. As shown in FIG. 6, in a state in which the engaging portion 33e is engaged with the recess 35b, the extending direction of the supporting groove 33c is the tangential direction of the circular arc of the guide hole 11g. The rotary shaft 32 can be moved from the guide hole 11g to the supporting groove 33c or from the supporting groove 33c to the guide hole 11g.

The spring stopper 36 is formed in an L-shape. The supporting portion 35a is interposed between the spring stopper 36 and a spring mounting portion 11j formed on the retainer 11 so that the resistance spring 35 is supported on the retainer 11 with the upper end thereof as a free end.

Each of thee components of the speed reduction ratio mechanisms 7a and 7b, the power transmission mechanism 8, and the power transmission mode switching mechanism 9 is assembled in the recess, which is formed, on the opposite side to the surface of the retainer 11 facing the frame 2. After that, a retainer cover 39 is mounted on the opposite side of the retainer 11 by means of a predetermined number (for example, four is shown in FIG. 3) of screws 40 so as to cover the components.

The power transmission mechanism 8 and the power transmission mode switching mechanism 9, which can have the above-mentioned structure, can be controlled by the ECU 68 to be switched to the following three modes described below. These three modes will be described with reference to FIGS. 6 to 8. FIG. 6 shows a left side view of the seat belt retractor shown in FIG. 3 in a power transmission interruption mode. FIG. 7 shows a left side view of the seat belt retractor shown in FIG. 3 in a low speed reduction ratio power transmission mode. FIG. 8 shows a left side view of the seat belt retractor 1 shown in FIG. 3 in a high speed reduction ratio power transmission mode.

(1) The Power Transmission Interruption Mode (Free Mode)

As shown in FIG. 6, in the power transmission interruption mode, the engaging portion 33e of the clutch arm 33 of the power transmission mode switching mechanism 9 is engaged with the recess 35b of the resistance spring 35. In addition, in the state in which the engaging portion 33e is engaged with the recess 35b, the ring member 19 is freely rotated since the engaging hook 34b of the clutch pawl 34 is not engaged with the ratchet teeth 19b of the ring member 19. For this reason, a torque transmission path (a path for both low speed and high torque transmission, as described below) is interrupted between the sun gear member 20 and the carrier gear 17.

As the rotary shaft 32 comes into contact with the right end of the guide hole 11g, the clutch gear 31 is positioned at the rightmost position. At the rightmost position, the clutch gear 31 is disengaged from the external teeth 17b of the carrier gear 17. For this reason, a torque transmission path (a path for both high speed and low torque transmission, as described below) is interrupted between the clutch gear 31 and the carrier gear 17.

Therefore, the power transmission interruption mode is a mode in which the spool 4 is not connected to the motor 6, the rotational torque of the motor 6 is not transmitted to the spool 4, and the rotational torque of the spool 4 is not transmitted to the motor 6. That is, the power transmission interruption mode can be defined as a disconnected state (which can correspond to a “disconnected state of the power transmission mechanism” in the present disclosure) in which a mechanical connected state (which can correspond to a “connected state of the power transmission mechanism” in the present disclosure) between the spool 4 and the power transmission mechanism 8 is released. In this state, the spool 4 is completely disengaged from the power transmission mechanism 8 (and motor 6). Thus, the unwinding resistance that is applied to the spool 4 by the power transmission mechanism 8, is lowered. Accordingly, since the spool 4 is easily rotated, the seat belt 3 retracted on the spool 4 is easily withdrawn (or unwound) regardless of the driving or stopping of the motor 6.

(2) The Low Speed Reduction Ratio Power Transmission Mode

As shown in FIG. 7, in the low speed reduction ratio power transmission mode, similar to the power transmission interruption mode, the engaging portion 33e of the clutch arm 33 is engaged with the recess 35b of the resistance spring 35. In addition, in the state in which the engaging portion 33e is engaged with the recess 35b, since the engaging hook 34b of the clutch pawl 34 is not engaged with the ratchet teeth 19b of the ring member 19, the ring member 19 is freely rotated. For this reason, a path for both low speed and high torque transmission is interrupted between the sun gear member 20 and the carrier gear 17.

As the rotary shaft 32 is positioned at the uppermost position (a position closest to the rotary shaft of the spool 4) in the middle of the guide hole 11g, the clutch gear 31 is also positioned at the uppermost position (a position closest to the rotary shaft of the spool 4). At the uppermost position, the clutch gear 31 is engaged with the external teeth 17b of the carrier gear 17. For this reason, a path for both high speed and low torque transmission is connected between the clutch gear 31 and the carrier gear 17. That is, the motor 6 is connected to the spool 4 through the motor gear 13, the connector gear 23, the idle gear 29, the upper connector gear 27, the lower connector gear 26, the clutch gear 31, the carrier gear 17, and the connector 14. Thus, the low speed reduction ratio power transmission mode is set. At the uppermost position of the rotary shaft 32, the rotary shaft 32 enters into the supporting grooves 33c of the clutch arm 33 so as to come into contact with the clutch arm 33.

The low speed reduction ratio power transmission mode is a power transmission mode with a low speed reduction ratio in which the path for both high speed and low torque transmission is set. In the low speed reduction ratio power transmission mode, it is possible to rapidly retract the seat belt by driving the motor 6. Both the low speed reduction ratio power transmission mode and the high speed reduction ratio power transmission mode can be defined as a connected state in which the spool 4 and the power transmission mechanism 8 are mechanically connected to each other so as to transmit the power of the motor 6 to the spool 4 through the power transmission mechanism 8.

In particular, when the motor 6 is driven and the power transmission mechanism 8 is set to the low speed reduction ratio power transmission mode or the high speed reduction ratio power transmission mode, the power of the motor 6 is transmitted to the spool 4. Furthermore, when the motor 6 is stopped and the power transmission mechanism 8 is set to the low speed reduction ratio power transmission mode or the high speed reduction ratio power transmission mode, a high unwinding resistance is applied to the spool 4 by the power transmission mechanism 8 mechanically connected to the spool 4. Accordingly, it is difficult to unwind (or withdraw) the seat belt 3 from the spool 4 or it is impossible to unwind (or withdraw) the seat belt 3 from the spool 4

(3) The High Speed Reduction Ratio Power Transmission Mode

As shown in FIG. 8, in the high speed reduction ratio power transmission mode, the engaging portion 33e of the clutch arm 33 is disengaged from the recess 35b of the resistance spring 35 and is positioned at the curved portion, which is formed at the upper end of the resistance spring 35 above the recess 35b. In addition, in the state in which the engaging portion 33e is disengaged from the recess 35b, since the engaging hook 34b of the clutch pawl 34 is engaged with the ratchet teeth 19b of the ring member 19 in the clockwise direction, the ring member 19 is not rotated in the clockwise direction. For this reason, a path for both low speed and high torque transmission is connected between the sun gear member 20 and the carrier gear 17. That is, the motor 6 is connected to the spool 4 through the motor gear 13, the connector gear 23, the idle gear 29, the external teeth 20b of the sun gear member 20, the sun gear 20a, the planet gears 18, the carrier gear 17, and the connector 14. Therefore, the power transmission path at a high speed reduction ratio is set by a planetary mechanism.

As the rotary shaft 32 comes in contact with the left end of the guide hole 11g, the clutch gear 31 is positioned at the leftmost position. At the leftmost position, the clutch gear 31 is disengaged from the external teeth 17b of the carrier gear 17. For this reason, a path for both high speed and low torque transmission is interrupted between the clutch gear 31 and the carrier gear 17.

In this manner, the high speed reduction ratio power transmission mode is a power transmission mode with high speed reduction ratio in which the path for both low speed and high torque transmission is set. In the high speed reduction ratio power transmission mode, the belt is retracted at high tension by driving the motor 6.

Power transmission mode switching among the power transmission interruption mode, the low speed reduction ratio power transmission mode, and the high speed reduction ratio power transmission mode is performed by the power transmission mode switching mechanism 9. For example, the mode switching can be performed according to the following patterns.

(1) Power Transmission Mode Switching from the Power Transmission Interruption Mode to the Low Speed Reduction Ratio Power Transmission Mode

In the power transmission interruption mode shown in FIG. 6, when the motor 6 is rotated in the normal direction, which can correspond to the clockwise rotation of the motor rotary shaft 6a in FIG. 6 (the belt retracting direction or the direction β in FIG. 3), the lower connector gear 26 and the pulleys 25 are rotated in the direction corresponding to the direction β through the motor gear 13, the connector gear 23, the idle gear 29, and the upper connector gear 27. In this case, the clutch gear 31 runs idle due to the clutch gear 31 not being engaged with the external teeth 17b of the carrier gear 17. Furthermore, since the rotary shaft 32 does not receive resistance, the clutch springs 24 are rotated in the same direction as the pulleys 25. For this reason, the clutch gear 31 and the rotary shaft 32 are moved to the left side along the guide hole 11g and then the rotary shaft 32 comes into contact with the clutch arm 33 as shown in FIG. 7.

At the position in which the rotary shaft 32 comes in contact with the clutch arm 33, the clutch gear 31 and the rotary shaft 32 shown in FIG. 7 are positioned at the uppermost position. The clutch gear 31 is engaged with the external teeth 17b of the carrier gear 17. For this reason, the torque of the clutch gear 31 is transmitted to the carrier gear 17 and then the carrier gear 17 is rotated. In this case, if there is slack in the seat belt 3, the seat belt 3 is retracted on the spool 4 by means of the rotation of the carrier gear 17. If the slack is removed, the spool 4 is not rotated, whereby the carrier gear 17 is also not rotated. For this reason, the clutch gear 31 is also not rotated due to the resistance from the carrier gear 17.

However, since the lower connector gear 26 is rotated by means of the rotational torque of the motor 6, a force is applied to the rotary shaft 32 toward the leftmost position due to the rotational torque of the lower connector gear 26. In this case, since the rotary shaft 32 comes in contact with the clutch arm 33, the rotary shaft 32 presses the clutch arm 33 due to a pressing force that is generated by the rotary shaft 32. However, at this time, since the tension of the seat belt 3 is smaller than a predetermined value, a moment for rotating the clutch arm 33 in the clockwise direction due to the pressing force of the rotary shaft 32 is smaller than the opposing moment in the clockwise direction due to the engaging force between the engaging portion 33e and the recess 35b. Therefore, the engaging portion 33e is not disengaged from the recess 35b so that the clutch arm 33 is not rotated. Accordingly, the rotary shaft 32 is stopped at the position in which the clutch arm 33 comes into contact with the rotary shaft 32.

With the stopping of the rotary shaft 32, the clutch gear 31 and the rotary shaft 32 are held at the uppermost position described above in FIG. 7. When the clutch gear 31 is held at the uppermost position, the clutch gear 31 is engaged with the external teeth 17b of the carrier gear 17. Thus, the path for both high speed and low torque transmission is connected between the clutch gear 31 and the carrier gear 17. Since the clutch arm 33 is not rotated, the clutch pawl 34 is also not rotated so that the engaging hook 34b is held at a position in which the clutch pawl 34 is not engaged with the ratchet teeth 19b. For this reason, the ring member 19 becomes free and the path for both low speed and high torque transmission is connected between the sun gear member 20 and the carrier gear 17.

In this manner, the power transmission mechanism 8 is switched from the power transmission interruption mode to the low speed reduction ratio power transmission mode so that the power transmission mechanism 8 is set in the low speed reduction ratio power transmission mode.

(2) Power Transmission Mode Switching from the Low Speed Reduction Ratio Power Transmission Mode to the High Speed Reduction Ratio Power Transmission Mode

The high speed reduction ratio power transmission mode is set through a relatively high rotational torque of the motor 6. In this case, the high speed reduction ratio power transmission mode is set from the power transmission interruption mode through the low speed reduction ratio power transmission mode.

The power transmission interruption mode is switched to the low speed reduction ratio power transmission mode in the same way as described above. However, the tension of the seat belt 3 is larger than the predetermined value at the time of setting the high speed reduction ratio power transmission mode. Accordingly, in the low speed reduction ratio power transmission mode shown in FIG. 7, the moment applied to the clutch arm 33 due to the pressing force of the rotary shaft 32 is larger than the opposing moment in the clockwise direction due to the engaging force between the engaging portion 33e and the recess 35b. Thus, the engaging portion 33e can be disengaged from the recess 35b.

Accordingly, when the clutch springs 24 are further rotated in the counter-clockwise direction, the rotary shaft 32 rotates the clutch arm 33 about the supporting shaft 11h in the clockwise direction and is moved to the left side along the guide hole 11g. For this reason, the clutch gear 31 is further moved to the left side. When the rotary shaft 32 comes into contact with the left end of the guide hole 11g, the rotary shaft 32 is not moved further so that the clutch gear 31, the rotary shaft 32, and the clutch springs 24 are stopped. Thus, as shown in FIG. 8, the clutch gear 31 and the rotary shaft 32 are positioned at the leftmost position. At the leftmost position, the clutch gear 31 is disengaged from the external teeth 17b of the carrier gear 17 so that the path for both high speed and low torque transmission is interrupted between the clutch gear 31 and the carrier gear 17.

When the clutch pawl 34 is rotated about the clutch pawl pin 38 in the counter-clockwise direction in conjunction with the rotation of the clutch arm 33, the clutch pawl 34 is placed at a position in which the engaging hook 34b can be engaged with the ratchet teeth 19b as shown in FIG. 8. In this case, since the sun gear member 20 is rotated by means of the rotational torque of the motor 6 and the ring member 19 is also rotated in the clockwise direction, the ratchet teeth 19b are engaged with the engaging hook 34b. Accordingly, the rotation of the ring member 19 is stopped and the path for both low speed and high torque transmission is connected between the sun gear member 20 and the carrier gear 17.

In this manner, the power transmission mechanism 8 is switched from the low speed reduction ratio power transmission mode to the high speed reduction ratio power transmission mode so as to be set in the high speed reduction ratio power transmission mode.

(3) Power Transmission Mode Switching from the High Speed Reduction Ratio Power Transmission Mode to the Power Transmission Interruption Mode (through the Low Speed Reduction Ratio Power Transmission Mode)

In the high speed reduction ratio power transmission mode shown in FIG. 8, when the motor 6 is rotated in the reverse direction, which can correspond to the counter-clockwise rotation of the motor rotary shaft 6a in FIG. 6 (the belt withdrawing direction or the direction α in FIG. 3), the lower connector gear 26 and the pulleys 25 are rotated in the direction opposite to the direction mentioned above. Then, since the clutch springs 24 are also rotated in the direction opposite to the direction mentioned above, the clutch gear 31 and the rotary shaft 32 are moved to the right side along the guide hole 11g while the clutch arm 33 is rotated in the counter-clockwise direction.

Since the clutch pawl 34 is rotated in the clockwise direction in conjunction with the counter-clockwise rotation of the clutch arm 33, the clutch pawl 34 is placed at a disengaging position, and thus is not engaged with the ratchet teeth 19b. Thus, the ring member 19 is freely rotated and the path for both low speed and high torque transmission is interrupted.

When the clutch gear 31 and the rotary shaft 32 are positioned at the uppermost position mentioned above, the clutch gear 31 is engaged with the external teeth 17b of the carrier gear 17 so as to temporarily be in the low speed reduction ratio power transmission mode shown in FIG. 7. However, since the clutch gear 31 and the rotary shaft 32 are continuously moved to the right side, the clutch gear 31 is disengaged from the external teeth 17b and runs idle. Accordingly, the path for both high speed and low torque transmission is temporarily connected but it is immediately interrupted. In addition, when the path for both high speed and low torque transmission is temporarily connected, the spool 4 is temporarily rotated in the belt withdrawing direction α but it is immediately stopped due to the reverse rotation of the motor 6.

When the rotary shaft 32 comes into contact with the right end of the guide hole 11g, the rotary shaft 32 is not moved further so that the clutch gear 31, the rotary shaft 32, and the clutch spring 24 are stopped. Thus, the clutch gear 31 and the rotary shaft 32 are positioned at the rightmost position shown in FIG. 6.

In this manner, the power transmission mechanism 8 is switched from the high speed reduction ratio power transmission mode to the power transmission interruption mode so that the power transmission mechanism 8 is set in the power transmission interruption mode.

In the above-mentioned embodiment, the power transmission mechanism 8 is switched by controlling the rotation of the motor 6.

Specifically, in the low speed reduction ratio power transmission mode, the motor 6 is controlled so as to be rotated in the normal direction so that the power transmission interruption mode is switched to the low speed reduction ratio power transmission mode and then the low speed reduction ratio power transmission mode is continued. On the other hand, the motor 6 is also controlled so as to be rotated in the reverse direction so that the low speed reduction ratio power transmission mode is switched to the power transmission interruption mode. Then, the low speed reduction ratio power transmission mode is released. In this case, when the motor 6 is controlled so as to be rotated in the reverse direction so that the power transmission mechanism 8 is switched from the connected state (the low speed reduction ratio power transmission mode) to the disconnected state (the power transmission interruption mode), the power transmission mechanism 8 is switched from the connected state (the low speed reduction ratio power transmission mode) to the disconnected state (the power transmission interruption mode) by means of the rotational speed difference between the motor 6 and the spool 4.

In addition, in the high speed reduction ratio power transmission mode, the motor 6 is controlled so as to be rotated in the reverse direction so that the low speed reduction ratio power transmission mode is switched to the high speed reduction ratio power transmission mode and then the high speed reduction ratio power transmission mode is continued. On the other hand, the motor 6 is also controlled so as to be rotated in the normal direction so that the high speed reduction ratio power transmission mode is switched to the low speed reduction ratio power transmission mode. Thus, the high speed reduction ratio power transmission mode is released.

Furthermore, the seat belt retractor 1 of the embodiment can have the following seven modes of the seat belt 3.

(1) Belt Storage Mode

The belt storage mode is a mode in which the seat belt 3 is not used and fully retracted on the spool 4. In the belt storage mode, the motor 6 of the seat belt retractor 1 is not driven and the power transmission mechanism 8 is set in the power transmission interruption mode. Thus, a very small belt tension acts on the seat belt 3 (which will be described in the description of a belt retracting mode to be described below) and the power consumption is zero.

(2) Belt Withdrawing Mode

The belt withdrawing mode is a mode in which the seat belt 3 is withdrawn from the spool 4 to be fastened. In the belt withdrawing mode, the seat belt retractor 1 is set in the power transmission interruption mode. Thus, a small force is enough for withdrawing the seat belt 3. In this mode, the motor 6 is not driven and the power consumption is zero.

(3) Belt Retracting Mode for Fitting

The belt retracting mode for fitting is a mode in which an excessively withdrawn amount of the seat belt 3 is retracted to fit the seat belt 3 about an occupant. The belt retracting mode is operated after the seat belt 3 is withdrawn and the tongue (for example, the tongue 62 shown in FIG. 1) is inserted into and latched with the buckle to turn on the buckle switch or when the occupant moves from the normal-use state of the seat belt 3 (the buckle switch 66a is ON) so that a predetermined amount of the seat belt 3 is withdrawn and then the occupant returns to the normal-use state. In the belt retracting mode for fitting, the motor 6 of the seat belt retractor 1 is driven in the belt retracting direction and the power transmission mechanism 8 is set in the low speed reduction ratio power transmission mode. Thus, the seat belt 3 is rapidly retracted with low torque and the motor 6 is stopped when a very small belt tension occurs so that the seat belt 3 is fastened around the occupant.

(4) Normal Fastening Mode (Comfort Mode)

The normal fastening mode (the comfort mode) is a mode in which the seat belt 3 is in the normal fastening state and is set after the completion of the belt retracting mode for fitting. In the normal fastening mode, the motor 6 of the seat belt retractor 1 is not driven and the power transmission mechanism 8 is set in the power transmission interruption mode. Thus, since a very small tension acts on the seat belt 3, the occupant does not feel discomfort even when fastening the seat belt 3. In addition, the power consumption is zero.

(5) Warning Mode

The warning mode is a mode in which there is a detection of the driver dozing off or of an obstacle in front of the vehicle during the drive of the vehicle in the normal fastening mode. Then, the retracting action of the seat belt 3 is repeated a predetermined number of times so as to warn the driver. In the warning mode, the motor 6 of the seat belt retractor 1 is set to drive repeatedly.

Thus, a relatively large belt tension (smaller than the belt tension in an emergency mode to be described below) and a very small tension are alternately applied to the seat belt 3 so that the driver is warned about dozing off or the obstacle in front of the vehicle.

(6) Emergency Mode

The emergency mode is a mode to be set when the vehicle is in high danger of colliding with an obstacle during the drive of the vehicle in the normal fastening mode. This mode has two stages as follows.

(i) Initial Stage

In the initial stage of the emergency mode, the motor 6 of the seat belt retractor 1 is rotated in the normal direction with a relatively high rotational torque. Accordingly, the clutch springs 24 are rotated in the power transmission interruption mode so that the clutch gear 31 and the rotary shaft 32 are moved to the uppermost position. Then the clutch gear 31 is engaged with the external teeth 17b of the carrier gear 17. At this moment, the slack of the seat belt 3 is removed and the tension of the seat belt 3 becomes smaller than a predetermined value. Accordingly, the resistance from the carrier gear 17 to the clutch gear 31 is relatively small. For this reason, even though the rotational torque of the motor 6 is relatively high, the rotary shaft 32 does not rotate the clutch arm 33. Thus, the power transmission mechanism 8 is set in the low speed reduction ratio power transmission mode. As a result, the torque of the clutch gear 31 is transmitted to the carrier gear 17 to rotate the carrier gear 17. Thus, the seat belt 3 is rapidly withdrawn with the low torque to rapidly remove the slack of the seat belt 3.

(ii) Late Stage

When the slack of the seat belt 3 is removed in the above-mentioned initial stage, the emergency mode proceeds to the late stage from the initial stage. In the late stage, as the tension of the seat belt exceeds the predetermined value, the resistance applied to the clutch gear 31 from the carrier gear 17 becomes relatively large. Accordingly, the carrier gear 17 and the clutch gear 31 are not rotated. However, since the lower connecter gear 26 is to be rotated by the rotational torque of the motor 6, force is applied to the rotary shaft 32 in the direction toward the leftmost position by the rotational torque of the lower connecter gear 26. In this case, since the rotational torque of the motor 6 is relatively high, the moment for rotating the clutch arm 33 in the clockwise direction by the pressing force of the rotary shaft 32 is larger than the opposing moment in the clockwise direction by the engaging force between the engaging portion 33e and the recess 35b. Therefore, the engaging portion 33e is disengaged from the recess 35b of the resistance spring 35. Then, the rotary shaft 32 is moved to the leftmost position while rotating the clutch arm 33. Since the clutch pawl 34 is rotated in conjunction with the rotation of the clutch arm 33, the engaging hook 34b of the clutch pawl 34 is engaged with the ratchet teeth 19b so that the ring member 19 is not rotated. For this reason, the power transmission mechanism 8 is set in the high speed reduction ratio power transmission mode. Thus, the seat belt 3 is retracted with high torque so as to restrain the occupant with extremely large belt tension.

(7) Belt Retracting Mode for Storage

The belt retracting mode for storage is a mode in which the seat belt 3 is fully retracted so as to be stored when the buckle switch (for example, the buckle switch 66a in FIG. 1) is turned off by pulling out the tongue (for example, the tongue 62 in FIG. 1) from the buckle for taking off the seat belt 3. In the belt retracting mode for storage, the motor 6 of the seat belt retractor 1 is driven in the belt retracting direction with relatively low rotational torque and the power transmission mechanism 8 is set in the low speed reduction ratio power transmission mode. Thus, the seat belt 3 is rapidly retracted with low torque.

Then, the seat belt 3 is fully retracted and the motor 6 is stopped at the time when a very small belt tension occurs so that the seat belt 3 is set in the belt storage mode with a very small belt tension on the seat belt 3.

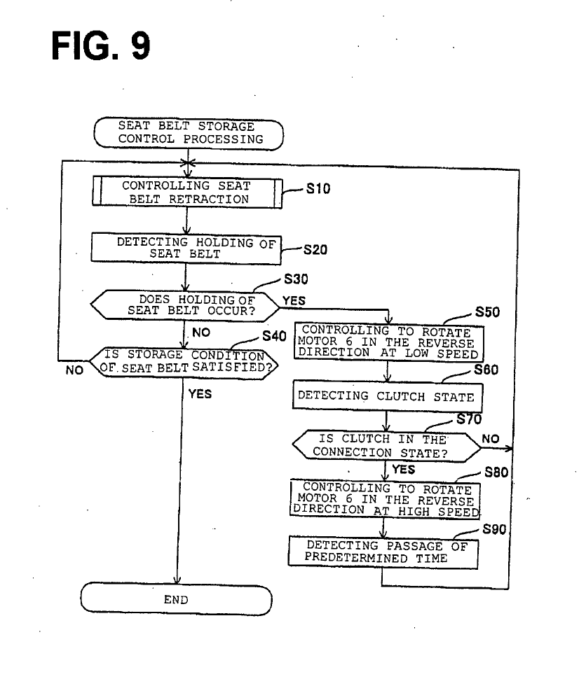

In the belt retracting mode for storage, after the retraction of the seat belt 3 for storage as described above, the motor 6 is controlled so as to be rotated in the reverse direction so that the power transmission mechanism 8 is switched from the connected state (the low speed reduction ratio power transmission mode) to the disconnected state (the power transmission interruption mode). In the belt retracting mode for storage, the seat belt 3 can be held and thus a tensile force can be applied to the seat belt 3. As to this situation, it is assumed that the possibilities are that the vehicle occupant withdrew the seat belt, that the seat belt merely came into contact with the shoulder, arms or the like of the vehicle occupant, or that the seat belt interfered with obstacles. Consequently, in consideration of the tensile force being applied to the seat belt 3 due to these possibilities, a control for detecting what kind of state the holding of the seat belt 3 has occurred is carried out so that a control function can be suitably performed for each of these possibilities. Since a control unit (for example, the ECU 68 shown in FIGS. 1 and 2) performs, for example, a “seat belt storage control process” shown in FIG. 9, the control function can be performed. A flow chart of the seat belt storage control process is shown in FIG. 9.

First, the retraction control (the storage control) of the seat belt is performed in the step S10 of the retractor control process shown in FIG. 9. In the retraction control of the seat belt, the motor 6 is controlled so as to be rotated in the normal direction so that the power transmission mechanism 8 is set in the low speed reduction ratio power transmission mode. Then, the withdrawn seat belt 3 is rapidly retracted (or stored) on the spool 4 with low torque. In this case, a “first direction” of the present disclosure can correspond to a normal rotational direction in which the motor 6 is rotated to retract the seat belt 3 on the spool 4.

In a step S20, the occurrence of the holding of the seat belt 3 is detected. Specifically, a motor current is detected or measured during the operation of the motor 6. Then, whether the holding of the seat belt 3 occurred or not is detected on the basis of the detected motor current. The motor current is detected by a motor current detector 69 shown in FIG. 2, which can correspond to a “first detecting unit” and a “motor ammeter” of the present disclosure.

Next, if the motor current detected in the step S20 is larger than a specified value, which can correspond to a “first reference current” of the present disclosure, the load of the motor is relatively high. Accordingly, in the step S30, it is determined that the holding of the seat belt 3 has occurred (the YES path in the step S30) and the procedure proceeds to a step S50. If the motor current detected in the step S20 is smaller than the specified value, the load of the motor is relatively low. Accordingly, it is determined that the holding of the seat belt 3 has not occurred (the NO path in the step S30) and the procedure proceeds to a step S40. The specified value (a first reference current) is set on the basis of the motor current when the holding of the seat belt 3 occurs or on the basis of the motor current when the holding of the seat belt 3 does not occur.

In the step S40, if the storage condition of the seat belt is not satisfied (the NO path in the step S40), the procedure returns to the step S10. If the storage condition of the seat belt is satisfied (the YES path in the step S40), the procedure is directly terminated.

In a case in which the holding of the seat belt 3 is caused by the fact that the seat belt merely comes into contact with the shoulder or arms or the like of the vehicle occupant or the seat belt interferes with obstacles, when the motor 6 is controlled so as to be rotated at low speed in the reverse direction, the rotational speed difference between the motor 6 and the spool 4 occurs so that the power transmission mechanism 8 is switched from the connected state (the low speed reduction ratio power transmission mode) to the disconnected state (the power transmission interruption mode). In a case in which the holding of the seat belt 3 is caused by the fact that the vehicle occupant withdrew the seat belt, when the motor 6 is controlled so as to be rotated at low speed in the reverse direction, the rotational speed difference between the motor 6 and the spool 4 does not occur so that the power transmission mechanism 8 is not switched from the connected state (the low speed reduction ratio power transmission mode) to the disconnected state (the power transmission interruption mode).

A control for detecting what kind of state the holding of the seat belt 3 has occurred is performed by detecting a state of the power transmission mechanism 8 after the motor 6 is controlled so as to be rotated at low speed in the reverse direction.

That is, in a step S50, the motor 6 is controlled so as to be rotated at low speed in the reverse direction so that the detection of what kind of state the holding of the seat belt 3 has occurred takes place. The reverse direction of the motor 6 can correspond to a “second direction opposite to the first direction” of the present disclosure. In this case, the low speed of the motor 6 is defined as a speed useful in detecting the holding state of the seat belt 3. Accordingly, only when the holding of the seat belt 3 occurs due to the fact that the seat belt merely comes into contact with the shoulder, arms or the like of the vehicle occupant or the seat belt interferes with obstacles, the speed of the motor 6 can be properly set as the speed at which the rotational speed difference between the motor 6 and the spool 4 occurs. The low speed can correspond to a “holding state discrimination speed” of the present disclosure. Furthermore, the holding state discrimination speed may have a specific speed value or may have any speed value within a predetermined speed range.

In a step S60, the state, which is referred to as a “clutch state,” of the power transmission mechanism 8 is detected. Specifically, when the motor 6 is operated, a motor current is detected or measured. Then, the determination of whether the power transmission mechanism 8 is in the connected state or the disconnected state is made on the basis of the motor current. The motor current is detected by the motor current detector 69 as shown in FIG. 2, which can correspond to a “second detecting unit” or a “motor ammeter” of the present disclosure.

If the motor current detected in the step S60 is smaller than a specified value, the load of the motor is relatively low. Accordingly, in a step S70, it is determined that the power transmission mechanism 8 is in the disconnected state (the clutch disconnected state or the NO path in the step S70). This state is a state in which the rotational speed difference between the motor 6 and the spool 4 occurs and it is presumed as a state in which the holding of the seat belt 3 occurs due to the fact that the seat belt merely comes into contact with the shoulder, arms, or the like of the vehicle occupant or the seat belt interferes with obstacles. Accordingly, when it is determined that the power transmission mechanism 8 is in the disconnected state (the clutch disconnected state), the procedure returns to the step S10 and then the seat belt is controlled so as to be retracted.

If the motor current detected in the step S60 is larger than a specified value, which can correspond to a “second reference current” of the present disclosure, the load of the motor is relatively high. Accordingly, in the step S80, it is determined that the power transmission mechanism 8 is in the connected state (the clutch connected state or the YES path in the step S70). This state is a state in which the rotational speed difference between the motor 6 and the spool 4 does not occur and it is presumed as a state in which the holding of the seat belt 3 occurs due to the fact that the vehicle occupant withdrew the seat belt 3. Accordingly, when it is determined that the power transmission mechanism 8 is in the connected state (the clutch connected state), the procedure proceeds to the step S80 so that the vehicle occupant can withdraw the seat belt. The specified value (the second reference current) is properly set on the basis of the motor current when the power transmission mechanism 8 is in the connected state or on the basis of the motor current when the power transmission mechanism 8 is in the disconnected state.

In the step 80, the motor 6 is controlled so as to be rotated in the reverse direction at a higher speed than the speed in the step S50 so that the power transmission mechanism 8 is reliably switched to the disconnected state (the power transmission interruption mode). The higher speed can correspond to a “speed higher than the holding state discrimination speed.” Accordingly, when the power transmission mechanism 8 is reliably switched to the disconnected state (the power transmission interruption mode), the vehicle occupant can withdraw the seat belt.

In a step S90, after the passage of a predetermined time is detected by the operation of a timer (not shown), the procedure returns to the step S10 so that the seat belt is controlled so as to be retracted. The predetermined time is properly set in consideration of the time required for the vehicle occupant to withdraw the seat belt.

When the holding of the seat belt 3 occurs by performing the seat belt storage control process shown in FIG. 9, it is possible to perform a control suitable to the factors or possibilities causing the holding of the seat belt. Thus, it is possible to smoothly store the seat belt.

In addition, the motor current detector 69 for detecting the current of the motor 6 can be used as a detecting unit for detecting whether the holding of the seat belt occurred or not or as a unit for detecting whether the power transmission mechanism 8 is in the connected state or the disconnected state. Accordingly, it is possible to simplify the structure thereof.

Moreover, since the two power transmission paths are set in the power transmission mechanism 8, it is possible to achieve two retracting performances that include rapid retraction of the seat belt for removing the slack of the seat belt 3 and retraction of the seat belt with high torque for restraining the occupant. The two power transmission paths include the low speed reduction ratio power transmission mode that is caused by the path for both high speed and low torque transmission and the high speed reduction ratio power transmission mode that is caused by the path for both low speed and high torque transmission.

Furthermore, since the torque of the motor 6 is efficiently transmitted to the spool 4 by the two power transmission paths, it is possible to rapidly achieve the two retracting performances with limited power consumption. In addition, since the seat belt is retracted with high torque by the path for low speed and high torque transmission, it is possible to reduce the rotational torque of the motor 6 as compared with a device in related art. For this reason, it is possible to reduce the power consumption of the motor 6 and to use a smaller motor, thereby making the seat belt retractor 1 more compact.

Also, since the two retracting performances can be achieved, the seat belt retractor 1 can have a pre-tensioning function using the rotational torque of the motor 6. Thus, it is possible to eliminate a pre-tensioner that uses a reaction gas for the seat belt retractor as in the related art, thereby reducing the manufacturing cost thereof.

In addition, the power transmission mechanism 8 can be set in the low speed reduction ratio power transmission mode or the high speed reduction ratio power transmission mode according to the tension of the seat belt 3. Accordingly, it is easy to switch the modes without controlling the rotational torque of the motor 6.

Also, the power transmission mechanism 8 can have the power transmission interruption mode in which the rotational torque of the motor 6 is not transmitted to the spool. Accordingly, the withdrawing of the seat belt 3, the normal fastening of the seat belt 3 without discomfort for the occupant, and the storage of the seat belt 3 when not in use can be performed regardless of the motor 6.

Furthermore, since the retracting operation of the seat belt 3 for storage is performed only by the rotational torque of the motor 6, it is possible to eliminate or reduce the urging force without an additional module, such as a tension reducer or the like. The urging force is caused by the retracting element, such as a spiral spring or the like, and it always acts on the seat belt 3 in the belt retracting direction.

In this case, even though the urging force by the retracting element is set in a minimum range for fitting the seat belt 3 to the occupant when the occupant puts on the seat belt 3, it is possible to reliably retract the seat belt 3 for storage so as to assist the retracting of the seat belt 3 by transmitting the torque of the motor 6 to the spool 4 in the low speed reduction ratio power transmission mode.

Since the high speed reduction ratio mechanism 7a can have a planetary mechanism, the path for both low speed and high torque transmission can be made more compact. For this reason, even though the power transmission mechanism 8 has both the low speed reduction ratio power transmission mode and the high speed reduction ratio power transmission mode, it is possible to efficiently reduce the size of the seat belt retractor 1.

Furthermore, since a carrier of the high speed reduction ratio mechanism 7a and the external teeth 17b of the low speed reduction ratio mechanism 7b can have a single common carrier gear 17, the number of parts can be reduced, thereby making the seat belt retractor more compact.

In addition, the power transmission mode switching mechanism 9 can control the rotation of the internal gear 19a of the planetary mechanism and the engagement between the small diametric clutch gear 31 and the external teeth 17b of the large diametric carrier gear 17 according to the tension of the seat belt 3, thereby making it easy to switch the power transmission modes.

The invention is not limited to the disclosed embodiments but may have various applications and modifications. For example, there may be other embodiments as provided below.

In one embodiment, the motor current detector 69 can be used as the first detecting unit for detecting whether the holding of the seat belt 3 has occurred or not while the second detecting unit is used for detecting whether the power transmission mechanism 8 is in the connected state or the disconnected state. However, in another embodiment, a sensor such as a hall IC can be used instead of the motor current detector 69 for at least one of the first detecting unit and the second detecting unit. Specifically, it can be possible to employ a structure for monitoring the state of the clutch by using a magnetic element (a magnet) and a magnetic hall sensor (hall IC) in conjunction with the operation of the clutch as a structure that uses a hall IC.

Although the structure of the seat belt retractor 1 to be mounted on a vehicle is disclosed, the retractor 1 can be used in a seat belt device mounted on the vehicle for transporting occupants, for example an automobile, an airplane, a ship, an electric train, etc. and it can be properly used in a seat belt device for retracting a seat belt by a seat belt motor.

The priority application Japanese Patent Application No. 2005-122259, filed Apr. 20, 2005, is incorporated by reference herein.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A seat belt retractor comprising:
a spool for retracting and unwinding a seat belt;
an electric motor;
a power transmission mechanism that is interposed between the electric motor and the spool, wherein the power transmission mechanism is configured to form a connected state in which the electric motor and the spool are connected to each other and a disconnected state in which the connected state is released;
a control unit for controlling the electric motor and the power transmission mechanism;
a first detecting unit for detecting whether the seat belt is held during the retraction of the seat belt; and
a second detecting unit for detecting whether the power transmission mechanism is in the connected state or the disconnected state.

2. The seat belt retractor according to claim 1, wherein, in the connected state of the power transmission mechanism, when the electric motor is driven so as to be rotated in a first direction, the spool is configured to be controlled so as to be rotated in the seat belt retracting direction so as to retract the seat belt.

3. The seat belt retractor according to claim 2, wherein, when the electric motor is configured to be driven so as to be rotated in a second direction opposite to the first direction so as to switch the power transmission mechanism from the connected state to the disconnected state, the power transmission mechanism is configured to be switched from the connected state to the disconnected state by means of a rotational speed difference between the electric motor and the spool.

4. The seat belt retractor according to claim 1, wherein, when a holding of the seat belt is detected by the first detecting unit during the retraction of the seat belt, the control unit is configured to control the electric motor so that the electric motor is rotated in a direction at a holding state discrimination speed.

5. The seat belt retractor according to claim 1, wherein, when the power transmission mechanism is in the connected state, the control unit is configured to determine that a holding of the seat belt occurred due to a vehicle occupant withdrawing the seat belt.

6. The seat belt retractor according to claim 1, wherein, when the power transmission mechanism is in the disconnected state, the control unit is configured to determine that a holding of the seat belt occurred due to the seat belt interfering with the vehicle occupant or obstacles.

7. The seat belt retractor according to claim 1, wherein the control unit is configured to determine a holding of the seat belt using results from the second detecting unit during the control of the electric motor.

8. The seat belt retractor according to claim 1, wherein the control unit is configured to control the electric motor so that the electric motor is rotated in a direction at a higher speed than a holding state discrimination speed when the control unit has determined that a holding of the seat belt has occurred due to a vehicle occupant withdrawing the seat belt.

9. The seat belt retractor according to claim 8, wherein the control unit is configured to make the determination that the holding of the seat belt has occurred based on results detected by the second detecting unit.

10. The seat belt retractor according to claim 1, wherein each of the first and the second detecting units includes a motor current detector for detecting a current of the electric motor.

11. The seat belt retractor according to claim 10, wherein, in a case in which an occurrence of a holding of the seat belt is detected, the control unit is configured to determine that the holding of the seat belt occurred when a current detected by the motor current detector is larger than a first reference current.

12. The seat belt retractor according to claim 10, wherein, the control unit is configured to determine that the power transmission mechanism is in the connected state when the current detected by the motor current detector is larger than a second reference current.

13. A seat belt device comprising:
a seat belt; and
a seat belt retractor, wherein the seat belt retractor comprises:
a spool for retracting and unwinding a seat belt;
an electric motor;
a power transmission mechanism that is interposed between the electric motor and the spool, wherein the power transmission mechanism is configured to form a connected state in which the electric motor and the spool are connected to each other and a disconnected state in which the connected state is released;
a control unit for controlling the electric motor and the power transmission mechanism;
a first detecting unit for detecting whether the seat belt is held during the retraction of the seat belt; and
a second detecting unit for detecting whether the power transmission mechanism is in the connected state or the disconnected state.

14. A seat belt retractor comprising:
a spool for retracting and unwinding a seat belt;
an electric motor;
a power transmission mechanism that is interposed between the electric motor and the spool, wherein the power transmission mechanism is configured to form a connected state in which the electric motor and the spool are connected to each other and a disconnected state in which the connected state is released;
a control unit for controlling the electric motor and the power transmission mechanism;
a detecting unit for detecting whether the seat belt is held during the retraction of the seat belt,
wherein, when a holding of the seat belt is detected by the detecting unit during the retraction of the seat belt, the control unit is configured to control the electric motor so that the electric motor is rotated in a direction at a holding state discrimination speed.

15. The seat belt retractor according to claim 14, wherein, in the connected state of the power transmission mechanism, when the electric motor is driven so as to be rotated in a first direction, the spool is configured to be controlled so as to be rotated in the seat belt retracting direction so as to retract the seat belt.

16. The seat belt retractor according to claim 15, wherein, when the electric motor is configured to be driven so as to be rotated in a second direction opposite to the first direction so as to switch the power transmission mechanism from the connected state to the disconnected state, the power transmission mechanism is configured to be switched from the connected state to the disconnected state by means of a rotational speed difference between the electric motor and the spool.

17. The seat belt retractor according to claim 14, wherein, when the power transmission mechanism is in the connected state, the control unit is configured to determine that a holding of the seat belt occurred due to a vehicle occupant withdrawing the seat belt.

18. The seat belt retractor according to claim 14, wherein, when the power transmission mechanism is in the disconnected state, the control unit is configured to determine that a holding of the seat belt occurred due to the seat belt interfering with the vehicle occupant or obstacles.

19. The seat belt retractor according to claim 14, wherein the control unit is configured to control the electric motor so that the electric motor is rotated in a direction at a higher speed than the holding state discrimination speed when the control unit has determined that a holding of the seat belt has occurred due to a vehicle occupant withdrawing the seat belt.
